(19) United States
(12) Patent Application Publication
(10) Pub. No.: US 2025/0224046 A1
(43) Pub. Date: Jul. 10, 2025

(54) OZONE BACKFLOW ARRESTER WITH FLOAT SWITCH

(71) Applicant: Water Tech Solutions, Inc., Mooresville, NC (US)

(72) Inventor: Gregory Sanders, Mooresville, NC (US)

(73) Assignee: Water Tech Solutions, Inc., Mooresville, NC (US)

(21) Appl. No.: 18/965,430

(22) Filed: Dec. 2, 2024

Related U.S. Application Data
(60) Provisional application No. 63/618,536, filed on Jan. 8, 2024.

(51) Int. Cl. F16K 31/18; C02F 1/78

(52) U.S. Cl. CPC F16K 31/18; C02F 1/78; C02F 2201/782; C02F 2303/04

(57) ABSTRACT

An ozone backflow arrester system includes a reservoir positioned between an ozone generator and a venturi injector or bubbler at the bottom of a water tank. The reservoir includes a float switch configured to detect a volume of backed up fluid in the system. The float switch is able to communicate a signal to a first three-way valve proximal to the reservoir or a second three-way valve distal to the reservoir to block gas or liquid flow through the system. Either three-way valve is able to vent backed up fluid or incoming gas into the surrounding environment through a vent. The float switch is able to work in conjunction with a vacuum switch connected proximate to the venturi injector or an impedance sensor within the reservoir.

### CROSS-REFERENCE TO RELATED APPLICATIONS

This application is related to and claims priority from the following US patents and patent applications: this application claims priority from and the benefit of U.S. Provisional Patent Application No. 63/618,536, filed Jan. 8, 2024, which is incorporated herein by reference in its entirety.

### BACKGROUND OF THE INVENTION

### 1. Field of the Invention

The present invention relates to ozone backflow arresters, and more specifically to backflow arresters including a float switch and external purging of backed up fluid.

### 2. Description of the Prior Art

It is generally known in the prior art to provide methods to prevent back flow of water into an ozone generator, such as using check valves or similar systems.

Prior art patent documents include the following:

US Patent Pub. No. 2011/0048038 for Multipurpose adiabatic potable water production apparatus and methods by inventors Merritt et al., filed May 15, 2007 and published Mar. 3, 2011, discloses an apparatus and methods for transforming water vapor into potable water by using a vapor compression refrigeration system which includes first and second cooling elements disposed in an air passage duct that provides an air circulation pattern driven by a fan or similar device. The circulating air undergoes cooling to a temperature below the dew point to collect water from the air. The collected water is stored in a principal storage vessel where ozone is injected to eliminate bacteria and contaminants. At least a portion of the recovered water is transferred to a secondary storage vessel where it is further cooled by refrigerant from the same compressor.

US Patent Pub. No. 2013/0224077 for Distributed Ozone Disinfection System by inventor Hinkle, filed Feb. 25, 2013 and published Aug. 29, 2013, discloses a distributed ozone disinfection system having a central ozone generation system, and ozone and water mixing systems. Each of the ozone and water mixing systems is positionable in a water supply piping at a water supply inlet for a sink faucets or water outlets. The distributed ozone disinfection system has vacuum switches, separate from vacuum switches positionable downstream which are in turn separate from the ozone and water mixing systems, and a plurality of oxidation reduction potential (ORPs) meters. The ORP meters are positionable downstream and separate from the ozone and water mixing systems. Optionally, the ozone and water mixing system includes a vacuum switch coupled with a gas injection venturi device.

US Patent Pub. No. 2006/0070947 for Method and apparatus for treating water by inventor Conrad, filed Sep. 15, 2003 and published Apr. 6, 2006, discloses a water treatment apparatus including a sand filter and a second stage purification step (e.g. ozonation). The sand filter is constructed as a plurality of individual components that are in fluid flow communication. At least that uppermost individual component of the sand filter is removable for cleaning.

U.S. Pat. No. 8,163,173 for Water treatment system by inventors Dellecave et al., filed Jul. 16, 2009 and issued Apr. 24, 2012, discloses a well water treatment system including a first ozonation tank that receives pressurized well water and introduces ozone into that well water. The ozone causes impurities to precipitate, which settle to the sides and bottom of the first tank. Remaining water is delivered by gravity flow to a second supply tank wherein the ozone is allowed to largely if not entirely dissipate from the water. When a household or other destination requires treated water, a pump in the supply tank operates to deliver water from the tank to that destination. The pump is operably positioned within the supply tank at an intermediate water level below precipitates floating on the surface and above precipitates that have settled in the tank.

US Patent Pub. No. 2022/0033289 for Vacuum regulated ozone generator by inventors Islas et al., filed Sep. 13, 2019 and published Feb. 3, 2022, discloses a water treatment system generating ozonated water using a vacuum operated injector with reduced vacuum switch lockup. The water treatment system includes an ozone generator, an ozone injector, a vacuum switch, and a pressure regulator. The ozone generator is configured to generate ozone. The ozone injector is coupled to the ozone generator via a hermetically sealed tubing, and the ozone injector is configured to inject the ozone into a water flow passing through the ozone injector. The vacuum switch is configured to operate the ozone generator based on a gaseous pressure inside the hermetically sealed tubing generated by the ozone injector. The pressure regulator is configured to regulate the gaseous pressure inside the hermetically sealed tubing to prevent the vacuum switch from trapped in a triggered state after the water flow stops.

U.S. Pat. No. 11,274,052 for Water treatment system by inventors Huang et al., filed Mar. 31, 2018 and issued Mar. 15, 2022, discloses a water treatment system including an ozone generator combined with an electrolytic chlorine generator in a compact, efficient and serviceable assembly. The system may include a modular and replaceable ozone generator, which allows a damaged or non-functional ozone generator to be quickly and efficiently replaced. In order to protect the ozone generator from damage, a fail-safe drain valve assembly may also be provided which will expel backflowing pool water before it is allowed to backflow into the ozone generator. The water treatment system may further include an insulated electrolytic chlorine generator that mitigates or eliminates leakage current for efficient operation.

### SUMMARY OF THE INVENTION

The present invention relates to ozone backflow arresters, and more specifically to backflow arresters including a float switch and external purging of backed up fluid.

It is an object of this invention to provide a more reliable method to prevent water backflow into ozone generators than traditional check valves, and in particular to a system that does not require instantaneous shut off of the ozone generator when backed up water is detected.

In one embodiment, the present invention is directed to an ozone backflow arrester, including a reservoir operable to receive ozone from an ozone generator via an intake tube, a first valve in the intake tube, configured to change orientations to vent the ozone to a surrounding environment, a float switch in the reservoir, a water level switch in the reservoir, and an injector connected to the reservoir via an outtake tube, wherein the injector is operable to inject the ozone into a fluid stream, wherein when the float switch or the water level switch are activated, the system activates a purge mode of the ozone generator, and wherein when both the float switch and the water level switch are activated, the first valve automatically reorients to vent to the surrounding environment.

In another embodiment, the present invention is directed to a method for preventing water backflow into an ozone generator, including a reservoir receiving ozone from an ozone generator via an intake tube, an injector injecting the ozone into a fluid stream, detecting an activation of a float switch or a water level switch within the reservoir, and subsequently activating a purge mode of the ozone generator, and detecting and activation of both the float switch and the water level switch, and a first valve within the intake tube subsequently reorienting to vent to a surrounding environment.

In yet another embodiment, the present invention is directed to an ozone backflow arrester, including a reservoir operable to receive ozone from an ozone generator via an intake tube, a first valve in the intake tube, configured to change orientations to vent the ozone to a surrounding environment, a float switch in the reservoir, an injector connected to the reservoir via an outtake tube, wherein the injector is operable to inject the ozone into a fluid stream, and a vacuum switch positioned between the reservoir and the injector, and configured to detect a loss of vacuum in the outtake tube, wherein when the float switch is activated, the system activates a purge mode of the ozone generator.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A is a schematic diagram of an ozone backflow arrester according to one embodiment of the present invention.

FIG. 1B is a schematic diagram of an ozone backflow arrester including a snubber system according to one embodiment of the present invention.

FIG. 1C is a schematic diagram of an ozone backflow arrester including an insulated conductivity probe according to one embodiment of the present invention.

FIG. 2 is a schematic diagram of an ozone backflow arrester according to one embodiment of the present invention.

FIG. 3 is a schematic diagram of a backflow circuit according to one embodiment of the present invention.

FIG. 4 is a schematic diagram of a system of the present invention.

### DETAILED DESCRIPTION

The present invention is generally directed to ozone backflow arresters, and more specifically to backflow arresters including a float switch and external purging of backed up fluid.

In one embodiment, the present invention is directed to an ozone backflow arrester, including a reservoir operable to receive ozone from an ozone generator via an intake tube, a first valve in the intake tube, configured to change orientations to vent the ozone to a surrounding environment, a float switch in the reservoir, a water level switch in the reservoir, and an injector connected to the reservoir via an outtake tube, wherein the injector is operable to inject the ozone into a fluid stream, wherein when the float switch or the water level switch are activated, the system activates a purge mode of the ozone generator, and wherein when both the float switch and the water level switch are activated, the first valve automatically reorients to vent to the surrounding environment.

In another embodiment, the present invention is directed to a method for preventing water backflow into an ozone generator, including a reservoir receiving ozone from an ozone generator via an intake tube, an injector injecting the ozone into a fluid stream, detecting an activation of a float switch or a water level switch within the reservoir, and subsequently activating a purge mode of the ozone generator, and detecting and activation of both the float switch and the water level switch, and a first valve within the intake tube subsequently reorienting to vent to a surrounding environment.

In yet another embodiment, the present invention is directed to an ozone backflow arrester, including a reservoir operable to receive ozone from an ozone generator via an intake tube, a first valve in the intake tube, configured to change orientations to vent the ozone to a surrounding environment, a float switch in the reservoir, an injector connected to the reservoir via an outtake tube, wherein the injector is operable to inject the ozone into a fluid stream, and a vacuum switch positioned between the reservoir and the injector, and configured to detect a loss of vacuum in the outtake tube, wherein when the float switch is activated, the system activates a purge mode of the ozone generator.

Water purification is an essential process for ensuring human safety and industrial efficiency for a variety of applications, not only for drinking water, but also for agriculture, swimming pools, water parks, and a variety of other applications. Ozone is commonly used for disinfecting water due to ozone's very strong oxidative properties. Additionally, unlike disinfectants such as chlorine, ozone does not leave behind chemical residue or remnants.

In water sanitization and purification systems, the ozone is typically delivered via an injector to a water flow under pressure, allowing the water (or other fluid) to dissolve and diffuse through the flowing water. A strong vacuum is produced in these systems when the liquid flows through the injector, and a sufficient pressure differential exists between the inlet and outlet of the injector, which helps bring the ozone and the liquid into contact under normal operating conditions. However, if the flow of the injector system is decreased or interrupted, often due to an issue with a pump or a valve, or due to a blockage, then liquid often begins to move into the ozone gas supply line. This is especially true where downstream flow is interrupted or blocked and the liquid is only able to move into the ozone gas supply line.

Ozone is produced through three primary methods: ultraviolent, corona discharge, and electrolysis. However, the poor output control and low output quantity from ultraviolent methods and the potential for harmful impurities from electrolytic methods means that corona discharge is by far the most common method. The corona discharge method applies high voltage across dry air to produce arcs that convert a percentage of oxygen (O₂) in the air to ozone (O₃). It should be noted that dry air is important for these systems, so water infiltration is particularly problematic. However, if water backs up into the corona discharge ozone generator, the risks to both the condition of the generator (which are often very expensive devices) and to the safety of people around are substantial due to the contact of high voltage arcs with water.

To address this issue, the most common backflow prevention means in the industry is the check valve, which only allows gas flow in a single direction. However, check valves are notoriously subject to failure, unless very high-quality materials (e.g., polytetrafluoroethylene (PTFE), perfluoroelastomers such as Kalrez®, etc.) are utilized. This is because, over time, reverse flow pressures will warp and deform the check valve components and degradation of the elastomers occurs due to ozone gas's oxidation properties, allowing for fluid flow in both directions. Slightly more advanced systems will often pair the use of the check valve with a system for detecting water backflow able to be used to close another valve along the gas line. Typically, those valves have been solenoid valves, but, like the check valves, solenoid valves are subject to frequent failures. Irregular pressures, power interruptions, or even small debris frequently cause solenoid valve failure issues. The sensors commonly used in these applications include capacitive sensors and electric eye sensors, operable to detect if fluids of higher opacity than the ozone (e.g., water) are present in particular, often transparent, sections of the ozone gas supply line. Electric eye sensors, however, are also vulnerable to debris blocking the line of sight, leading to false positives for backflow.

In each of these systems, gas flow from the ozone generator is typically stopped and the ozone generator is powered down to minimize chances of damage, though if a solenoid valve is used to stop the gas flow, this does not guarantee a lack of water infiltration. Immediate shut down of these systems has the potential to cause damage to the ozone generator over time. Therefore, a system is needed that is capable of more reliably preventing backflow of water into an ozone injection system while also reducing stress on ozone generators, through purging. Generally speaking, the present invention utilizes a float switch, a water detection switch, a loss of vacuum switch, the condition of each of which is able to be monitored, as well as multiple different systems for detecting if backflow occurs and three-way ball valves for diverting gas or backed up liquid to the surrounding environment.

While individual subcomponents of the system, such as float switches, are known in the art for other purposes, the combination of those systems for use in a backflow arrester, including diverting either gas or water to atmosphere or drain, represents a novel and nonobvious solution over prior art systems and methods. Ozone water disinfection systems in general, such as U.S. Patent Pub. No. 2013/0224077, which is incorporated herein by reference in its entirety, are known in the art, but as mentioned above, the back flow arrester mechanisms for such systems are lacking. Systems such as that described in the '077 publication or in U.S. Patent Pub. No. 2022/0033289 utilize switches, such as vacuum switches, that have feedback control for turning an ozone generator on or off based on the pressure within the actual injector tubing, but these feedback control systems are not focused on detecting or preventing backflow, instead focusing on maximizing ozone distribution efficiency. While vacuum switches sometimes provide possible indicators for backflow, the same indicators are also potentially indicative of different, unrelated phenomena. For example, the system described in U.S. Patent Pub. No. 2011/0048038 utilizes a float switch in combination with an ozone generator, but in a much different orientation, where the float switch is used to activate the ozone generator (indicating there is sufficient water in a tank), and to stop filling the tank, but is not used for backflow detection or prevention purposes. The float switches used in U.S. Patent Pub. No 2006/0070947 and U.S. Pat. No. 8,163,173 are used for similar purposes of determining water level for the purpose of filling a tank as well.

Prior art systems that do attempt to address the backflow issue utilize a much different set-up from the present invention. For example, the system described in U.S. Pat. No. 11,274,052 relies on a seal between a float bottom and a drain orifice, with buoyancy directing the liquid flow to drain as long as the drain is free and open. However, this system does not address redirecting gas flow or issues of high water pressures, relative to atmospheric pressure, in a fail-safe environment. The water in the '052 system is able to be redirected by the float buoyancy for long periods of time without detection by an operator, increasing likelihood of malfunction as the system essentially lacks any actual sensor feedback control. Furthermore, the '052 system lacks a means of redirecting ozone gas flow to the surrounding environment or for operating a purge phase where gas flow is able to continue without producing the ozone.

Referring now to the drawings in general, the illustrations are for the purpose of describing one or more preferred embodiments of the invention and are not intended to limit the invention thereto.

The present system is able to include three separate safety feedback mechanisms for detecting backflow, allowing for redundancy that ensures detection even if one system fails, though one of ordinary skill in the art will understand that the present invention is also able to include only a subset of the three described mechanisms. The three mechanisms include, but are not limited to: a float switch in a reservoir, one or more impedance sensors in the reservoir, and/or a vacuum switch for a venturi injector.

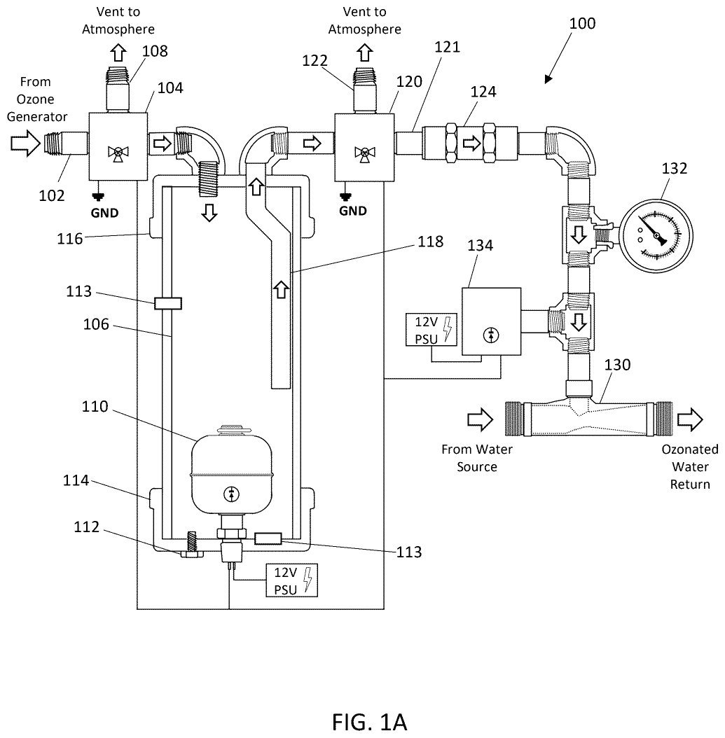

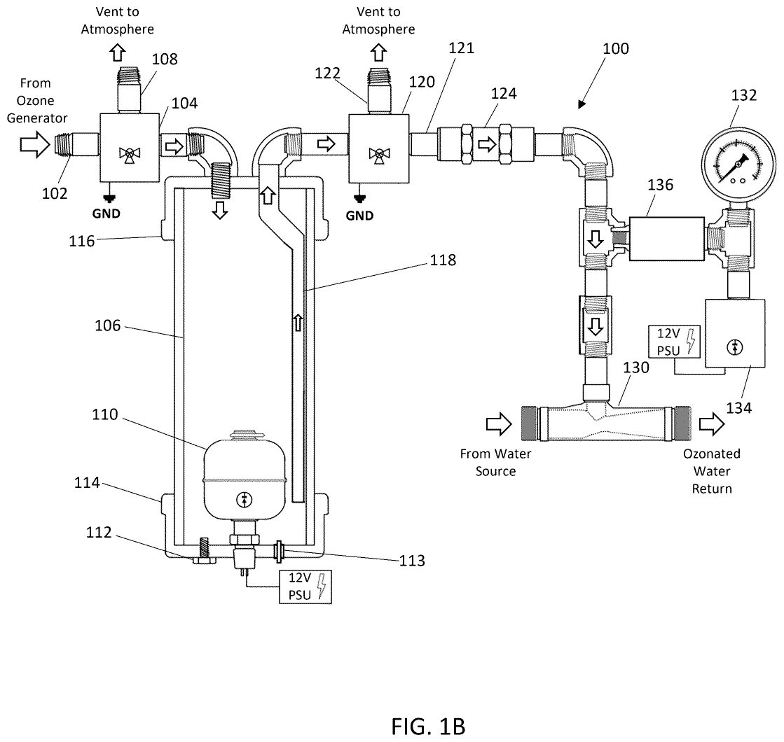

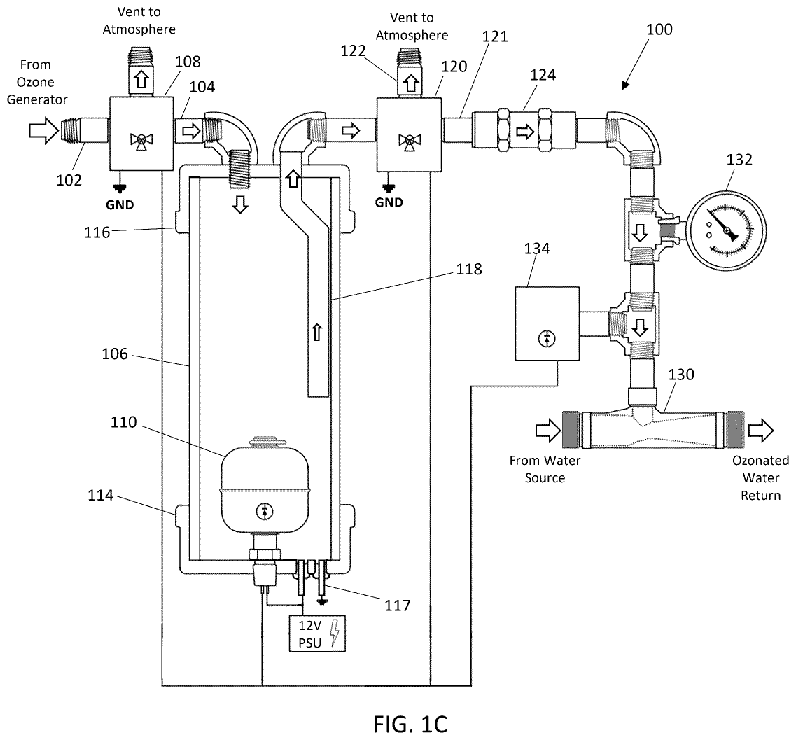

FIG. 1A is a schematic diagram of an ozone backflow arrester according to one embodiment of the present invention. In the backflow arrester system 100, ozone generated by an ozone generator enters a first three-way valve 104 via an intake tube 102. In one embodiment, in a normal operating configuration, the first three-way valve 104 provides a path between the intake tube 102 and a reservoir 106. However, in one embodiment, the first three-way valve 104 is operable to shift positions to instead create a path between the intake tube 102 and a first vent 108 to the surrounding environment or a path between the reservoir 106 and the first vent 108 to the surrounding environment. This essentially allows the first three-way valve 104 to vent backed up gas or liquid (e.g., water) to the environment, or to divert gas flow from the ozone generator to the atmosphere, or to a destruct device that converts O₃ to O₂. In one embodiment, the opening by which ozone enters the reservoir 106 is defined through a top surface of the reservoir 106. In a preferred embodiment, the first three-way valve 104 is an L-valve, as an open connection between all of the intake tube 102, the reservoir 106, and the first vent 108 simultaneously is not generally desired, but one of ordinary skill in the art will understand that T-valves are also compatible with the present invention. In one embodiment, the first three-way valve 104 is a three-way ball valve, or any other type of three-way valve, including, but not limited to, the valve described in U.S. Pat. No. 10,641,402, which is incorporated herein by reference in its entirety. In one embodiment, the first three-way valve 104 is a ball valve made from stainless steel with polytetrafluoroethylene (PTFE) seats. The resistance of PTFE to ozone gas allows for the valve to function over longer periods of time without requiring replacement. Furthermore, the use of ball valves provides for a more reliable system than solenoid valves for regular opening or closing of the valves.

In one embodiment, the first three-way valve 104 includes a fail safe spring return such that, during power loss or loss of compressed air to the system, the first three-way valve 104 will change orientation to automatically divert the incoming gas or divert backed up liquid to the environment. Therefore, instead of trying to contain liquid in the ozone gas line, the liquid pressure is released to the atmosphere or surrounding environment.

In one embodiment, the reservoir 106 includes at least one float switch 110 positioned at the bottom of the reservoir 106. The size of the reservoir 106 is configured such that the at least one float switch 110 will activate long before backed up liquid reaches the top of the reservoir 106. In one embodiment, upon activation, the at least one float switch 110 is configured to transmit an electrical signal to the first three-way valve 104 and/or to a second three-way valve 120, causing the first three-way valve 104 and/or the second three-way valve 120 to automatically change orientation to block flow of ozone and/or liquid through the system and/or to vent ozone and/or liquid to the surrounding environment. In one embodiment, the at least one float switch 110 is in wired communication with the first three-way valve 104 and/or the second three-way valve 120, while, in another embodiment, the at least one float switch 110 is connected to one or more other components via a wireless network (e.g., WI-FI, BLUETOOTH, etc.). In one embodiment, the at least one float switch 110, upon activation, is configured to automatically transmit an electrical signal to an ozone generator, configured to turn off production for or purge the ozone generator. Purging the ozone generator means that no electricity is applied, allowing dry air or oxygen to continue flowing through. In a preferred embodiment, the at least one float switch 110 is a vertical stem-mounted flow switch, but one of ordinary skill in the art will understand that horizontal and/or vertical flow switches are compatible with the present invention. Additionally, one of ordinary skill in the art will understand that stem-mounted and cable-suspended flow switches are both compatible with the present invention. In one embodiment, the float switch 110 is connected to at least one power supply unit (PSU) (e.g., a 12-24 DCV power source). In one embodiment, the material of the reservoir 106 includes stainless steel and/or any other suitable ozone gas-resistant material.

In one embodiment, the float switch 110 includes a 2-inch diameter float ball with a specific gravity of approximately 0.6 kg/m³. The use of this specific gravity allows liquids lighter than water to also cause the float switch 110 to rise upon backflow.

In one embodiment, the reservoir 106 includes at least one test drain plug 112 allowing for manual testing of the float switch activation, drainage of liquid from the reservoir 106, or other issues in the system. In one embodiment, the at least one test drain plug 112 is inserted through an opening in a bottom surface of the reservoir 106. In one embodiment, the at least one test drain plug 112 is a ¼ inch test drain plug, but one of ordinary skill in the art will understand that the dimensions of the test drain plug 112 are not intended to be limited according to the present invention. In one embodiment, the at least one test drain plug 112 is connected to the reservoir 106 via threaded connection. In one embodiment, the at least one test drain plug 112 includes at least one sealing element (e.g., an O-ring). In one embodiment, a first coupling plate 114 is welded, threaded onto, or attached using a sanitary clamp and plate, to a bottom end of the reservoir 106. In one embodiment, a second coupling plate 116 is welded to a top end of the reservoir 106. In one embodiment, the at least one test drain plug 112 extends through the first coupling plate 114. In one embodiment, the first coupling plate 114 has a thickness of approximately ¼ inches, but one of ordinary skill in the art will understand that the thickness or dimensions of the first coupling plate 114 are not intended to be limited according to the present invention. Removal of the at least one test drain plug 112 allows a small wire or screwdriver to be used to raise the float switch 110 and simulate an alarm condition for testing and validating the system as being in good operating condition.

In one embodiment, the reservoir 106 includes at least one impedance sensor 113 operable to detect when the water level in the reservoir 106 rises to specific heights. The impedance sensor 113, and corresponding communication to one or more switching mechanisms, acts as a 2^{nd} detection area for a water problem, with loss of vacuum detection being first. Depending on the location of the at least one impedance sensor 113, it is able to respond to small films of water that have crept back into the ozone gas line, or specifically respond to larger water volumes. When the fluid level rises to a specific point, a circuit for the at least one impedance sensor 113 is completed, thereby allowing for detection that fluid has reached a specific height. In one embodiment, in order to do this, the at least one impedance sensor 113 is preferably attached to the bottom plate of the reservoir 106, similar to a drain plug, but preferably on the opposite side of the bottom plate relative to the at least one test drain plug 112. In one embodiment, the reservoir 106 includes a plurality of impedance sensors 113 operable to detect when the water level reaches various heights in the reservoir 106. In one embodiment, the at least one impedance sensor 113 is connected via wired or wireless connection to the ozone generator, the first three-way valve 104, and/or the second three-way valve 120, such that one or more of the at least one impedance sensor 113 is operable to transmits commands to the ozone generator to turn ozone production off (or subsequently turn on) based on the sensor data from the at least one impedance sensor 113 and/or to the first three-way valve 104 and/or second three-way valve 120 to change orientations based on the sensor data. The at least one impedance sensor 113 is useful for detecting backflow even if the float switch 110 fails, or to provide additional information regarding the specific amount of backflow, especially if the backflow exceeds detectable limits of the float switch 110.

A tube 118 extends upwardly and outwardly from the reservoir 106 and connects the reservoir 106 to the second three-way valve 120. In one embodiment, in a normal operating configuration, the second three-way valve 120 provides a path between the tube 118 and a distal tube 121. However, in one embodiment, the second three-way valve 120 is operable to shift positions to instead create a path between the tube 118 and a second vent 122 to the surrounding environment or a path between the distal tube 121 and the second vent 122 to the surrounding environment. This essentially allows the second three-way valve 120 to vent backed up gas or liquid (e.g., water) to the environment, or to divert gas flow to the atmosphere. In a preferred embodiment, the second three-way valve 120 is an L-valve, as an open connection between all of the tube 118, the distal tube 121, and the vent 122 simultaneously is not generally desired, but one of ordinary skill in the art will understand that T-valves are also compatible with the present invention. In one embodiment, the second three-way valve 120 is a three-way ball valve, or any other type of three-way valve, including, but not limited to, the valve described in U.S. Pat. No. 10,641,402. In one embodiment, the second three-way valve 120 is a ball valve made from stainless steel with polytetrafluoroethylene (PTFE) seats. The resistance of PTFE to ozone gas allows for the valve to function over longer periods of time without requiring replacement. Furthermore, the use of ball valves provides for a more reliable system than solenoid valves for regular opening or closing of the valves.

In a preferred embodiment, the tube 118 is bent such that the bottom of the tube 118 or a portion of the bottom of the tube 118 is against the side wall of the reservoir 106. This is useful, as if any liquid backs up into the system, the liquid will not fall directly on the float switch 110, which is preferably centered in the reservoir 106. If falling liquid is applying downward pressure on the float switch 110, especially if the backed up liquid is flowing at high velocity, that potentially prevents the float switch 110 from rising and activating, thus delaying the responsiveness of the system. Thus, the relative geometry of the tube 118 and the float switch 110 helps to prevent incoming backed up liquid flow from delaying the triggering of the float switch 110. While this is only a concern if the at least one impedance switch 113 fails, it still provides additional insurance that at least one of the feedback mechanisms will operate properly.

In one embodiment, the second three-way valve 120 includes a fail safe spring return such that, during power loss or loss of compressed air to the system, the second three-way valve 120 will change orientation to automatically divert the incoming gas or divert backed up liquid to the environment. Therefore, instead of trying to contain potentially high pressure liquid in the ozone gas line, the liquid pressure is released to the atmosphere or surrounding environment.

In one embodiment, after passing through the distal tube 121, the ozone passes through a check valve 124. In a preferred embodiment, the check valve 124 is a soft seat check valve. In a preferred embodiment, the check valve 124 is formed from one or more high quality materials configured to not substantially warp or degrade over time, including, but not limited to, polytetrafluoroethylene (PTFE). The check valve 124 prevents water backflow by only allowing flow in a single direction. The use of specific materials with the check valve 124 and the additional of additional measures, such as the float switch 110 help to overcome limitations traditionally associated with check valves in backflow prevention systems. After exiting the check valve 124, the ozone continues down a tubing path until it enters an injector 130 for dissolving and diffusing into a water stream, originating from a water source. In one embodiment, the injector 130 is a venturi injector (e.g., a MAZZEI injector, etc.).

In one embodiment, the tubing connecting the check valve 124 with the injector 130 is connected with at least one vacuum or compound gauge 132, operable to observe the vacuum or pressure to the injector 130. In one embodiment, the vacuum gauge 132 is in wired or wireless communication with the first three-way valve 104, the second three-way valve 120, the ozone generator, and/or a vacuum switch 134. In one embodiment, the vacuum switch 134 is in wired or wireless communication with the first three-way valve, the second three-way valve, and/or an ozone generator. In one embodiment, the vacuum switch 134 is configured to turn off ozone gas production by the ozone generator if the vacuum pressure of the system drops below a preset threshold, and is configured to turn on the ozone generator when the pressure rises above the preset threshold (or a secondary threshold). The vacuum switch 134 is able to act as a first indicator of water issues within the system and is able to present an alarm or caution state to human or mechanical operators of the system via BLUETOOTH or other internet-based communication. In one embodiment, the vacuum switch 134 is configured to cause a change in orientation of the first three-way valve 104 and/or the second three-way valve 120 if the vacuum pressure of the systems drops below a preset threshold, and is configured to cause another change in orientation when the pressure rises above the preset threshold (or a secondary threshold). In one embodiment, the vacuum switch 134 is connected to at least one power supply unit (PSU) (e.g., a 12-24 DCV power source). In one embodiment, the vacuum switch 134 includes a five to ten second delay in activating an alarm (i.e., causing a change in operation to the ozone generator, first three-way valve 104, second three-way valve 120, etc.) in order to reduce the likelihood of false positives.

While a preferred embodiment of the present invention includes a corona discharge ozone generator, one of ordinary skill in the art will understand that any type of ozone generator, including ultraviolet (UV) and electrolytic ozone generators are also compatible with the present invention. For the purposes of the present invention, descriptions of feedback mechanisms that turn off the ozone production by the ozone generator as described above are also able to refer to switching the ozone generator to a purge mode, wherein dry air or oxygen flow continues, but the voltage is no longer applied, thereby not generating ozone.

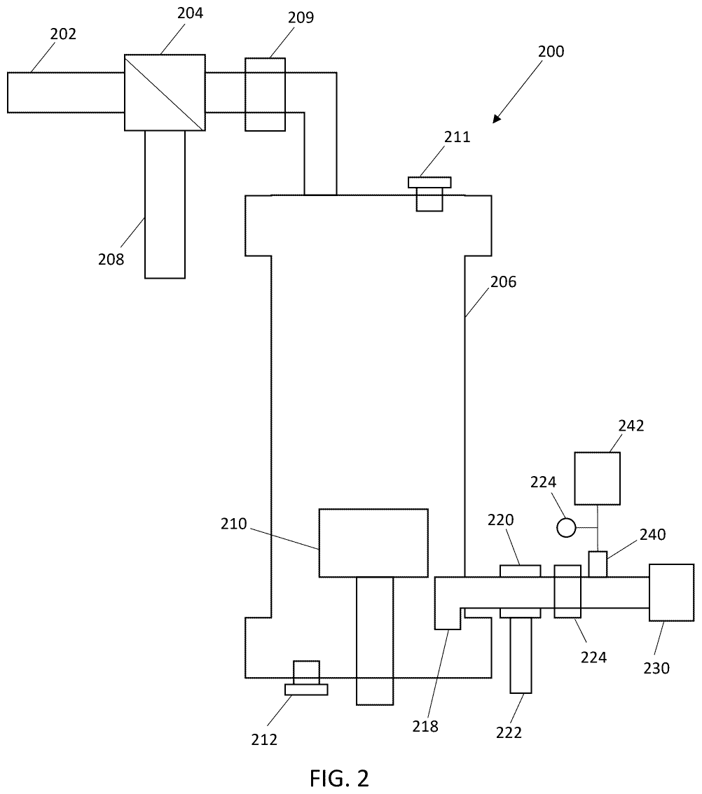

One of ordinary skill in the art will understand that the snubber system 136 discussed with reference to FIG. 2 is also able to be included, as shown in FIG. 1B. Preferably, the snubber system is positioned between the pressure gauge 132 and the vacuum switch 134 and the system as a whole to prevent damage to the pressure gauge 132 and the vacuum switch 134 from ozone gas degradation. In one embodiment, the ozone gas concentration in the incoming gas stream is as high as 18% by weight, so the isolation scrubber helps prevent damage from this otherwise highly corrosive stream. Preferably, the snubber is formed from stainless steel and PTFE, which are both substantially inert to ozone corrosion and thus withstand the incoming gas stream.

In one embodiment, as shown in FIG. 1C, the reservoir includes one or more insulated conductivity probes 117. In one embodiment, the one or more insulated conductivity probes 117 are positioned along a bottom surface of the reservoir 116. In one embodiment, the one or more insulated conductivity probes 117 extend through a thickness of a wall of the reservoir 116 and the gaps between the conductivity probes 117 and the reservoir 116 wall are sealed in a fluid-tight manner.

FIG. 2 is a schematic diagram of an ozone backflow arrester according to one embodiment of the present invention. In one embodiment, gas (i.e., ozone) from an ozone generator enters a first three-way valve 204 through an intake tube 202. In one embodiment, in a normal operating configuration, the first three-way valve 204 provides a path between the intake tube 202 and a reservoir 206. However, in one embodiment, the first three-way valve 204 is operable to shift positions to instead create a path between the intake tube 202 and a first vent 208 to the surrounding environment or a path between the reservoir 206 and the first vent 208 to the surrounding environment, or a destruct device that catalyzes ozone gas. This essentially allows the first three-way valve 204 to vent backed up gas or liquid (e.g., water) to the environment, or to divert gas flow from the ozone generator to the atmosphere. In one embodiment, the opening by which ozone enters the reservoir 206 is defined through a top surface of the reservoir 206. In a preferred embodiment, the first three-way valve 204 is an L-valve, as an open connection between all of the intake tube 202, the reservoir 206, and the first vent 208 simultaneously is not generally desired, but one of ordinary skill in the art will understand that T-valves are also compatible with the present invention. In one embodiment, the first three-way valve 204 is a three-way ball valve, or any other type of three-way valve, including, but not limited to, the valve described in U.S. Pat. No. 10,641,402. In one embodiment, the first three-way valve 204 is a ball valve made from stainless steel with polytetrafluoroethylene (PTFE) seats. The resistance of PTFE to ozone gas allows for the valve to function over longer periods of time without requiring replacement. Furthermore, the use of ball valves provides for a more reliable system than solenoid valves for regular opening or closing of the valves. Additionally, ball valves typically have a much higher pressure rating than solenoid valves.

In one embodiment, the first three-way valve 204 includes a fail safe spring return such that, during power loss or loss of compressed air to the system, the first three-way valve 204 will change orientation to automatically divert the incoming gas or divert backed up liquid, should it make it past the second three-way valve 220, to the environment. Therefore, instead of trying to contain liquid in the ozone gas line, the liquid pressure is released to the atmosphere or surrounding environment.

In one embodiment, between the first three-way valve 204 and the reservoir 206 is a first check valve 209, operable to prevent, or at least slow, back flow from the reservoir 206 to the ozone generator by only permitting fluid flow in one direction. In a preferred embodiment, the first check valve 209 is a soft seat check valve. In a preferred embodiment, the first check valve 209 is formed from one or more high quality materials configured to not substantially warp or degrade over time, including, but not limited to, polytetrafluoroethylene (PTFE) or KALREZ. The first check valve 209 prevents water backflow by only allowing gas flow in a single direction. The use of specific materials with the first check valve 209 and the additional of additional measures, such as the float switch 210 help to overcome limitations traditionally associated with check valves in backflow prevention systems. After exiting the first check valve 209, the ozone continues into the reservoir 206. In one embodiment, the system does not include a first check valve 209, and instead the only check valve in the system is the positioned between the reservoir 206 and the injector 230, corresponding to the second check valve 224.

In one embodiment, the reservoir 206 includes at least one float switch 210 positioned at the bottom of the reservoir 206. The size of the reservoir 206 is configured such that the at least one float switch 210 will activate long before backed up liquid reaches the top of the reservoir 206. In one embodiment, upon activation, the at least one float switch 210 is configured to transmit an electrical signal to the first three-way valve 204 and/or to a second three-way valve 220, causing the first three-way valve 204 and/or the second three-way valve 220 to automatically change orientation to block flow of ozone and/or liquid through the system and/or to vent ozone and/or liquid to the surrounding environment. In one embodiment, the at least one float switch 210 is in wired communication with the first three-way valve 204 and/or the second three-way valve 220, while, in another embodiment, the at least one float switch 210 is connected to one or more other components via a wireless network (e.g., WI-FI, BLUETOOTH, etc.). In one embodiment, the at least one float switch 210, upon activation, is configured to automatically transmit an electrical signal to an ozone generator, configured to turn off ozone production by the ozone generator. In a preferred embodiment, the at least one float switch 210 is a vertical stem-mounted flow switch, but one of ordinary skill in the art will understand that horizontal and/or vertical flow switches are compatible with the present invention. Additionally, one of ordinary skill in the art will understand that stem-mounted and cable-suspended flow switches are both compatible with the present invention. In one embodiment, the float switch 210 is connected to at least one power supply unit (PSU) (e.g., a 12V power source). In one embodiment, the material of the reservoir 206 includes stainless steel and/or any other suitable ozone gas resistant materials.

In one embodiment, the float switch 210 includes a 2 inch diameter float ball with a response to a specific gravity of approximately 0.6 kg/m³. The use of this specific gravity allows liquids lighter than water to also cause the float switch 210 to rise upon backflow, making the float switch 210 very buoyant.

In one embodiment, the reservoir 206 includes a first test drain plug 212 allowing for testing of leaks or other issues in the system. In one embodiment, the first test drain plug 212 is inserted through an opening in a bottom surface of the reservoir 206. In one embodiment, the first test drain plug 212 is a ¼ inch test drain plug, but one of ordinary skill in the art will understand that the dimensions of the first test drain plug 212 are not intended to be limited according to the present invention. In one embodiment, the first test drain plug 212 is connected to the reservoir 206 via threaded connection. In one embodiment, the first drain plug 212 includes at least one sealing element (e.g., an O-ring). In one embodiment, a first coupling plate is welded, or attached via a sanitary clamp device with an O-ring (e.g., a PTFE O-ring), to a bottom end of the reservoir 206. In one embodiment, a second coupling plate is welded, or attached via a sanitary clamp plate, to a top end of the reservoir 206. In one embodiment, the first test drain plug 212 extends through the first coupling plate. In one embodiment, the first coupling plate has a thickness of approximately ¼ inches, but one of ordinary skill in the art will understand that the thickness or dimensions of the first coupling plate are not intended to be limited according to the present invention. Removal of the first test drain plug 212 allows a small wire or screwdriver to be used to raise the float switch 210 and simulate an alarm condition for testing and validating the system as being in good operating condition.

In one embodiment, the reservoir 206 includes a second test drain plug 211 allowing for testing of leaks or other issues in the system. In one embodiment, the second test drain plug 211 is inserted through an opening in a top surface of the reservoir 206. In one embodiment, the second test drain plug 211 is a ¼ inch test drain plug, but one of ordinary skill in the art will understand that the dimensions of the second test drain plug 211 are not intended to be limited according to the present invention. In one embodiment, the second test drain plug 211 is connected to the reservoir 206 via threaded connection. In one embodiment, the second test drain plug 211 includes at least one sealing element (e.g., an O-ring). In one embodiment, the second test drain plug 211 extends through the second coupling plate. One of ordinary skill in the art will understand that the present invention is not intended to be limited to two test drain plugs or any specific number of test drain plugs.

A tube 218 extends outwardly through a side wall (or through a top surface) from the reservoir 206 and connects the reservoir 206 to the second three-way valve 220. In one embodiment, in a normal operating configuration, the second three-way valve 220 provides a path between the tube 218 and a venturi injector 230. However, in one embodiment, the second three-way valve 220 is operable to shift positions to instead create a path between the tube 218 and a second vent 222 to the surrounding environment or a path between the venturi injector 230 and the second vent 222 to the surrounding environment. This essentially allows the second three-way valve 220 to vent backed up gas or liquid (e.g., water) to the environment, or to divert gas flow to the atmosphere. In a preferred embodiment, the second three-way valve 220 is an L-valve, as an open connection between all of the tube 218, the venturi injector 230, and the vent 222 simultaneously is not generally desired, but one of ordinary skill in the art will understand that T-valves are also compatible with the present invention. In one embodiment, the second three-way valve 220 is a three-way ball valve, or any other type of three-way valve, including, but not limited to, the valve described in U.S. Pat. No. 10,641,402. In one embodiment, the second three-way valve 220 is a ball valve made from stainless steel with polytetrafluoroethylene (PTFE) seats. The resistance of PTFE to ozone gas allows for the valve to function over longer periods of time without requiring replacement. Furthermore, the use of ball valves provides for a more reliable system than solenoid valves for regular opening or closing of the valves.

In one embodiment, the second three-way valve 220 includes a fail safe spring return such that, during power loss or loss of compressed air to the system, the second three-way valve 220 will change orientation to automatically divert the incoming gas or divert backed up liquid to the environment. Therefore, instead of trying to contain liquid in the ozone gas line, the liquid pressure is released to the atmosphere or surrounding environment.

In one embodiment, a second check valve 224 suspenders and a belt is positioned between the second three-way valve 220 and the venturi injector 230. In a preferred embodiment, the second check valve 224 is a soft seat check valve. In a preferred embodiment, the second check valve 224 is formed from one or more high quality materials configured to not substantially warp or degrade over time, including, but not limited to, polytetrafluoroethylene (PTFE). The second check valve 224 prevents water backflow by only allowing flow in a single direction. After exiting the check valve 224, the ozone continues down a tubing path until it enters the injector 230 for dissolving and diffusing into a water stream, originating from a water source. In one embodiment, the injector 230 is a venturi injector (e.g., a MAZZEI injector, etc.).

In one embodiment, a snubber 240 (e.g., an isolation snubber) is positioned between the second three-way valve 220 and the injector 230. In one embodiment, the isolation snubber 240 is connected to a gauge 224 and a transducer 242. In one embodiment, the transducer 242 operates at between approximately 4 and approximately 20 mA. Alternatively, the transducer 242 is able to be supplemented with or replaced by a vacuum switch within an adjustable vacuum range depending of the characteristics of the injector 230. In one embodiment, the gauge 224 is a compound gauge operable to show readings between −30 and 30 psi. The isolation snubber 240 is operable to reduce damage of the gauge 224 as a result of sudden shifts in pressure/vacuum in the system and isolates the gauge and/or switch devices from the corrosive nature of the ozone gas.

In one embodiment, the present system has three indication levels. The first level is a caution level, in which a light attached to the system or elsewhere preferably begins blinking, changing color, or providing another visual indicator. In one embodiment, the first level is entered when the vacuum of the injector is detected to be out of range of a predetermined threshold of time (e.g., 5 seconds, 15 seconds, 30 seconds, 1 minute, etc.). In one embodiment, in the first level, detection of the vacuum being out of range also initiates the ozone generator to begin purging, flowing dry air or O₂, but all valves 104 & 120 left in normal operating position.

In the second stage, the first alarm state, the water switch 113 detects backflow liquid in the reservoir. In one embodiment, if the water switch 113 detects a predetermined amount of backflow (e.g., ⅛″ of water, etc.), alarm state 1 is entered, causing the ozone generator to enter purge mode and causing the gas to be vented to atmosphere or a destruct device via the first three-way valve.

In the third stage, the second alarm state, if the float switch is then activated, (alarm state 2), then both the first three-way valve and the second three-way valve are configured to vent to atmosphere or to a destruct device. In this state, the ozone generator is maintained in a purge state, as it is difficult to get water to go back against air pressure.

Alarm stages 2 or 3 generally require operator attention to put the system back in normal operation, typically leading to an investigation into why backflow occurred from the injector. The system is then manually or automatically reset and any water in the reservoir needs to be removed before normal operation is able to begin again. In one embodiment, the drain plug is used to remove the water, after which air is purged from the reservoir.

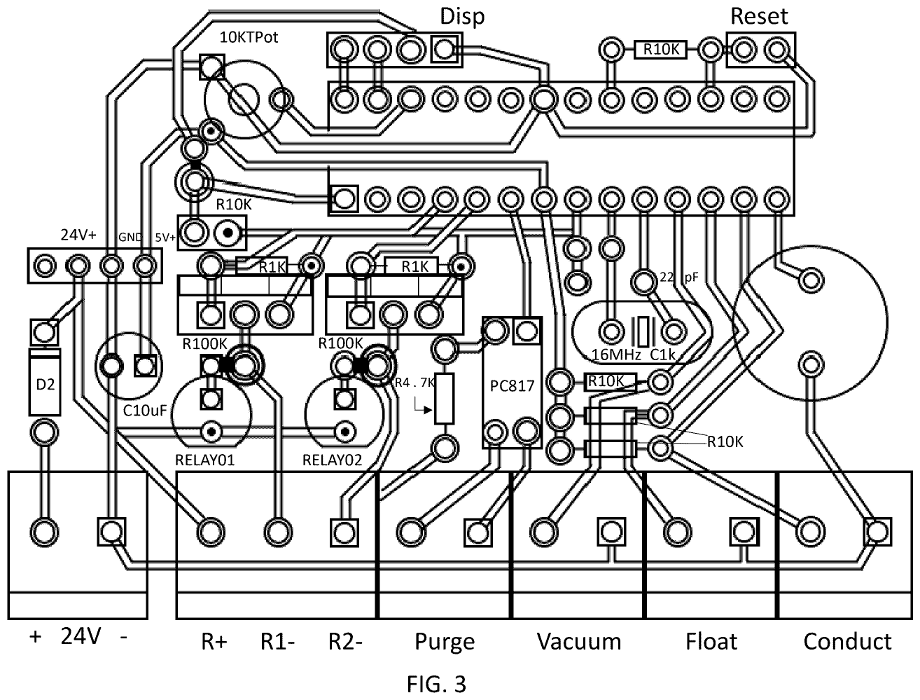

FIG. 3 is a schematic diagram of a backflow circuit according to one embodiment of the present invention. In one embodiment, as shown in FIG. 3, the system includes one or more indicator lights, providing a visual indication of when specific subcomponents of the system (e.g., the float switch, the vacuum switch, etc.) are triggered or faulty, or when specific modes (e.g., purge mode, diversion of the valves to atmosphere, etc.) have been engaged or disengaged. In one embodiment, in addition to or in lieu of the one or more indicator lights, the system includes one or more audio indicators (e.g., distinct tones or patterns of noises, etc.). The ability to read the pattern of lights on the control panel of the backflow circuit, or listen to relevant noises, allows an operator to understand a particular “code” indicating what issues have arisen with the ozone injector and, thus, how best to resolve any issues.

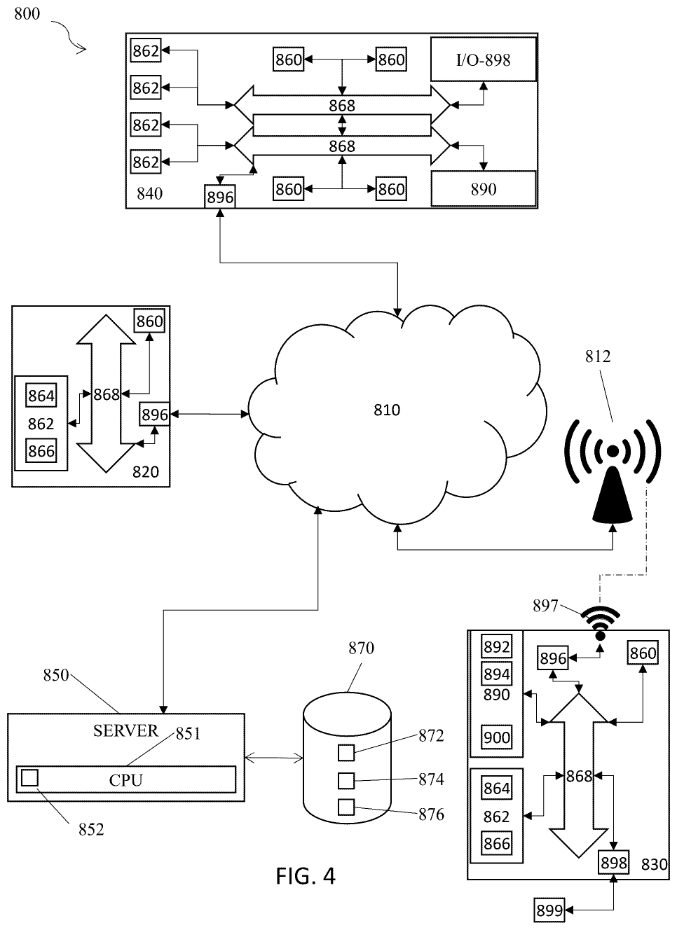

FIG. 4 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 4, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable to be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 4, is operable to include other components that are not explicitly shown in FIG. 4, or is operable to utilize an architecture completely different than that shown in FIG. 4. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. An ozone backflow arrester, comprising:
a reservoir operable to receive ozone from an ozone generator via an intake tube;
a first valve in the intake tube, configured to change orientations to vent the ozone to a surrounding environment;
a float switch in the reservoir;
a water level switch in the reservoir; and
an injector connected to the reservoir via an outtake tube, wherein the injector is operable to inject the ozone into a fluid stream;
wherein when the float switch or the water level switch are activated, the system activates a purge mode of the ozone generator; and
wherein when both the float switch and the water level switch are activated, the first valve automatically reorients to vent to the surrounding environment.

2. The ozone backflow arrester of claim 1, wherein the first valve is a ball valve.

3. The ozone backflow arrester of claim 1, wherein the outtake tube includes a second valve configured to vent the ozone to the surrounding environment, and wherein when both the float switch and the water level switch are activated, the second valve automatically reorients to vent to the surrounding environment.

4. The ozone backflow arrester of claim 1, wherein the float switch includes a float ball having a specific gravity of approximately 0.6 kg/m³.

5. The ozone backflow arrester of claim 1, wherein the reservoir includes a test drain plug.

6. The ozone backflow arrester of claim 1, wherein the water level switch includes at least one impedance sensor.

7. The ozone backflow arrester of claim 1, wherein an end of the outtake tube is positioned along an inner wall of the reservoir and is oriented downwardly.

8. The ozone backflow arrester of claim 1, further including an isolation snubber.

9. A method for preventing water backflow into an ozone generator, comprising:
a reservoir receiving ozone from an ozone generator via an intake tube;
an injector injecting the ozone into a fluid stream;
detecting an activation of a float switch or a water level switch within the reservoir, and subsequently activating a purge mode of the ozone generator; and
detecting and activation of both the float switch and the water level switch, and a first valve within the intake tube subsequently reorienting to vent to a surrounding environment.

10. The method of claim 9, wherein the first is a ball valve.

11. The method of claim 9, further comprising a second valve between the reservoir and the injector automatically reorienting to vent to the surrounding environment when the float switch and the water level switch are both activated.

12. The method of claim 9, wherein the float switch includes a float ball having a specific gravity of approximately 0.6 kg/m³.

13. The method of claim 9, wherein the reservoir includes a test drain plug.

14. The method of claim 9, wherein the water level switch includes at least one impedance sensor.

15. The method of claim 9, wherein an end of an outtake tube connecting the reservoir and the injector is positioned along an inner wall of the reservoir and is oriented downwardly.

16. The method of claim 9, further comprising an isolation snubber limiting an ozone gas concentration.

17. An ozone backflow arrester, comprising:
a reservoir operable to receive ozone from an ozone generator via an intake tube;
a first valve in the intake tube, configured to change orientations to vent the ozone to a surrounding environment;
a float switch in the reservoir;
an injector connected to the reservoir via an outtake tube, wherein the injector is operable to inject the ozone into a fluid stream; and
a vacuum switch positioned between the reservoir and the injector, and configured to detect a loss of vacuum in the outtake tube;
wherein when the float switch is activated, the system activates a purge mode of the ozone generator.

18. The ozone backflow arrester of claim 17, wherein the first valve is a ball valve.

19. The ozone backflow arrester of claim 17, wherein the float switch includes a float ball having a specific gravity of approximately 0.6 kg/m³.

20. The ozone backflow arrester of claim 17, wherein an end of the outtake tube is positioned along an inner wall of the reservoir and is oriented downwardly.
